(19) United States
(12) Patent Application Publication
(10) Pub. No.: US 2014/0254057 A1
(43) Pub. Date: Sep. 11, 2014

(54) SURGE SUPPRESSION APPARATUS

(71) Applicant: CHICONY POWER TECHNOLOGY CO., LTD., New Taipei City (TW)

(72) Inventors: Jyun-Ji CHEN, New Taipei City (TW); Wei-Shun HUANG, New Taipei City (TW)

(73) Assignee: CHICONY POWER TECHNOLOGY CO., LTD., New Taipei City (TW)

(21) Appl. No.: 13/793,989

(22) Filed: Mar. 11, 2013

(51) Int. Cl. H02H 9/08

(52) U.S. Cl. CPC H02H 9/08
USPC 361/118

(57) ABSTRACT

A surge suppression apparatus is applied to an alternating current power supply apparatus. The surge suppression apparatus includes a rectification unit and a first transient voltage surge suppressor. The rectification unit includes a first diode, a second diode, a third diode, and a fourth diode. The first transient voltage surge suppressor is electrically connected to the first diode, the second diode, the third diode, and the fourth diode. The alternating current power supply apparatus is electrically connected to the first diode, the second diode, the third diode, and the fourth diode. The first diode is electrically connected to the second diode and the third diode. The fourth diode is electrically connected to the second diode and the third diode.

### BACKGROUND OF THE INVENTION

1. Field of the Invention

The present invention relates to a surge suppression apparatus, and especially relates to an improved surge suppression apparatus.

2. Description of the Related Art

The surge protection device (SPD) is a very common electronic component. The surge protection device is used to suppress and absorb the surge.

However, the surge protection device is limited to the relationship of the inrush current and the clamping voltage. For example, the clamping voltage will be 880 volts if the inrush current is 200 amperes. In another word, the protected component has to withstand 800 volts. The price of the protected component is higher if the withstanding voltage of the protected component is higher. Therefore, the cost of the protected component is increasing.

### SUMMARY OF THE INVENTION

In order to solve the above-mentioned problems, an object of the present invention is to provide a surge suppression apparatus.

In order to achieve the object of the present invention mentioned above, the surge suppression apparatus is applied to an alternating current power supply apparatus. The surge suppression apparatus includes a rectification unit electrically connected to the alternating current power supply apparatus, and a first transient voltage surge suppressor electrically connected to the rectification unit. The rectification unit includes a first diode, a second diode, a third diode, and a fourth diode. The first diode is electrically connected to the alternating current power supply apparatus and the first transient voltage surge suppressor. The second diode is electrically connected to the alternating current power supply apparatus, the first transient voltage surge suppressor, and the first diode. The third diode is electrically connected to the alternating current power supply apparatus, the first transient voltage surge suppressor, and the first diode. The fourth diode is electrically connected to the alternating current power supply apparatus, the first transient voltage surge suppressor, the second diode, and the third diode.

### BRIEF DESCRIPTION OF DRAWING

FIG. 1 shows a block diagram of a first embodiment of the surge suppression apparatus of the present invention.

FIG. 2 shows a block diagram of a second embodiment of the surge suppression apparatus of the present invention.

FIG. 3 shows a block diagram of a third embodiment of the surge suppression apparatus of the present invention.

FIG. 4 shows a block diagram of a fourth embodiment of the surge suppression apparatus of the present invention.

FIG. 5 shows a block diagram of a fifth embodiment of the surge suppression apparatus of the present invention.

FIG. 6 shows a block diagram of a sixth embodiment of the surge suppression apparatus of the present invention.

FIG. 7 shows a block diagram of a seventh embodiment of the surge suppression apparatus of the present invention.

### DETAILED DESCRIPTION OF THE INVENTION

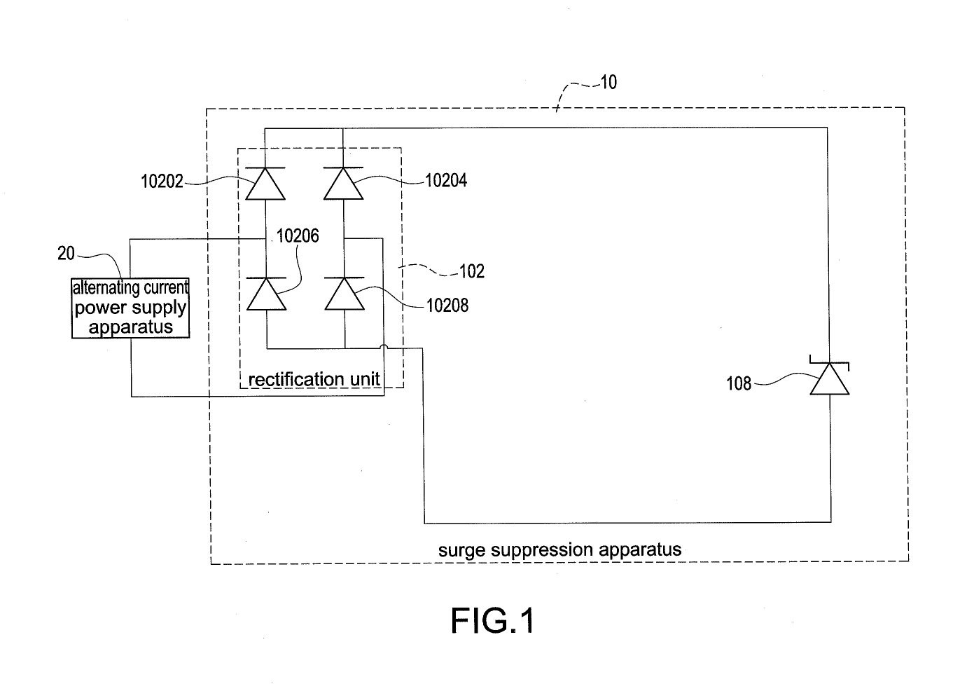

FIG. 1 shows a block diagram of a first embodiment of the surge suppression apparatus of the present invention. A surge suppression apparatus 10 is applied to an alternating current power supply apparatus 20. The surge suppression apparatus 10 includes a rectification unit 102 and a first transient voltage surge suppressor (TVSS) 108.

The rectification unit 102 includes a first diode 10202, a second diode 10204, a third diode 10206, and a fourth diode 10208.

The first transient voltage surge suppressor 108 is electrically connected to the first diode 10202, the second diode 10204, the third diode 10206, and the fourth diode 10208. The alternating current power supply apparatus 20 is electrically connected to the first diode 10202, the second diode 10204, the third diode 10206, and the fourth diode 10208. The first diode 10202 is electrically connected to the second diode 10204 and the third diode 10206. The fourth diode 10208 is electrically connected to the second diode 10204 and the third diode 10206.

The first transient voltage surge suppressor 108 is a high impedance component without the surge. The first transient voltage surge suppressor 108 is a low impedance component with the surge.

The alternating current power supply apparatus 20 supplies a power to an electronic device (not shown in FIG. 1) without the surge. The first transient voltage surge suppressor 108 is used to suppress and absorb the surge. The rectification unit 102 is used to rectify the surge (because the first transient voltage surge suppressor 108 is a unidirectional component).

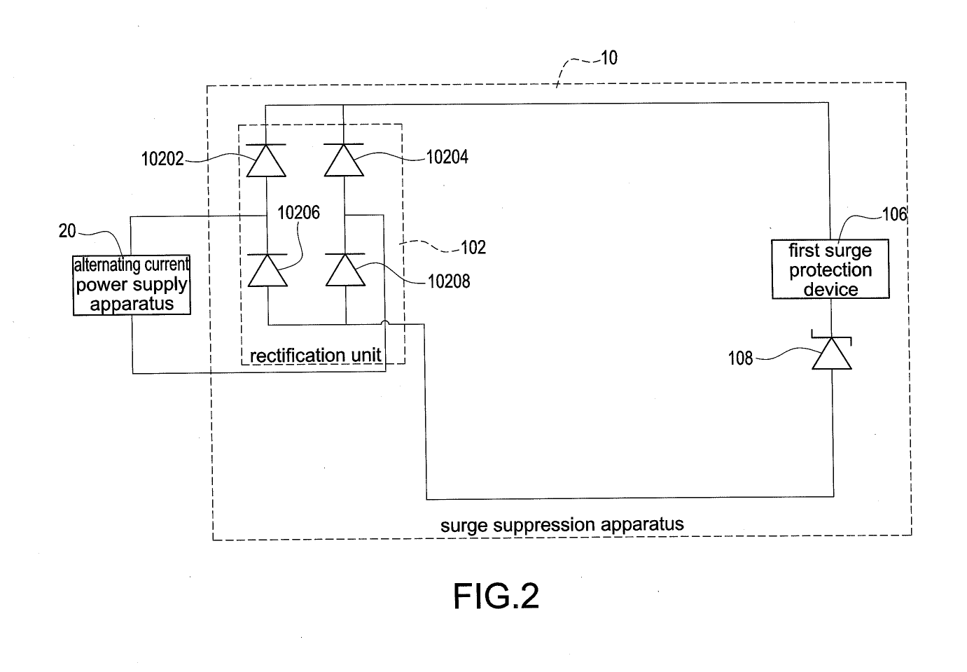

FIG. 2 shows a block diagram of a second embodiment of the surge suppression apparatus of the present invention. FIG. 2 is similar to FIG. 1. Therefore, the descriptions for FIG. 2 are omitted. Moreover, the surge suppression apparatus 10 further includes a first surge protection device 106. The first surge protection device 106 is, for example but not limited to, a metal oxide varistor (MOV), a gas tube, or a resistor.

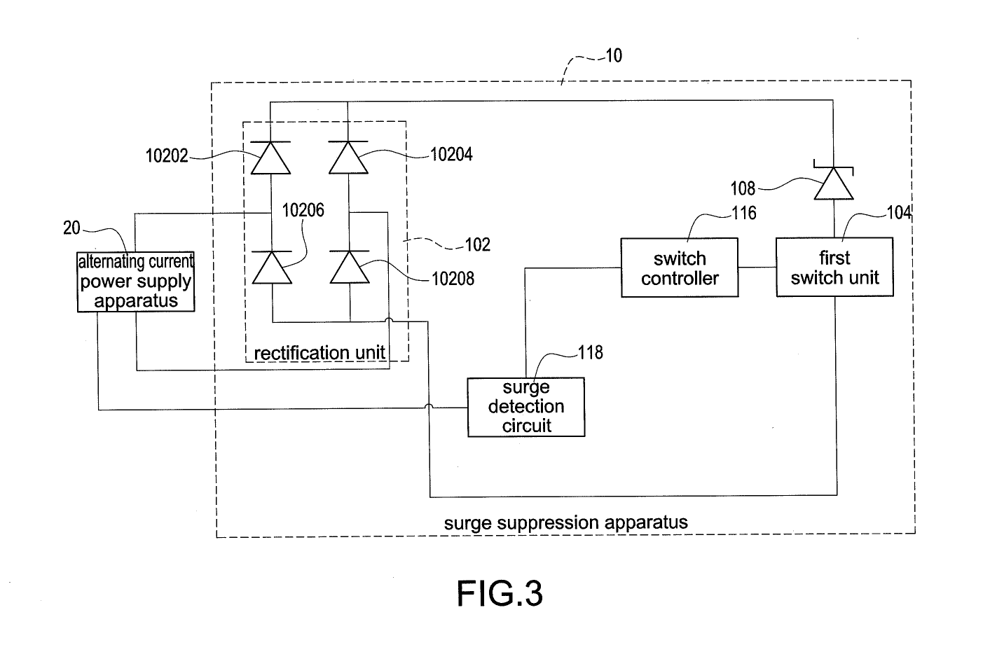

FIG. 3 shows a block diagram of a third embodiment of the surge suppression apparatus of the present invention. A surge suppression apparatus 10 is applied to an alternating current power supply apparatus 20. The surge suppression apparatus 10 includes a rectification unit 102, a first switch unit 104, a first transient voltage surge suppressor 108, a switch controller 116, and a surge detection circuit 118.

The rectification unit 102 includes a first diode 10202, a second diode 10204, a third diode 10206, and a fourth diode 10208.

The alternating current power supply apparatus 20 is electrically connected to the first diode 10202, the second diode 10204, the third diode 10206, the fourth diode 10208, and the surge detection circuit 118. The first diode 10202 is electrically connected to the second diode 10204, the third diode 10206, and the first transient voltage surge suppressor 108. The second diode 10204 is electrically connected to the fourth diode 10208 and the first transient voltage surge suppressor 108. The third diode 10206 is electrically connected to the fourth diode 10208 and the first switch unit 104. The fourth diode 10208 is electrically connected to the first switch unit 104.

The switch controller 116 is electrically connected to the surge detection circuit 118 and the first switch unit 104. The first switch unit 104 is electrically connected to the first transient voltage surge suppressor 108.

The first transient voltage surge suppressor 108 is a high impedance component without the surge. The first transient voltage surge suppressor 108 is a low impedance component with the surge.

The surge detection circuit 118 detects the surge and informs the switch controller 116. The switch controller 116 is configured to cut off the first switch unit 104 without the surge. The alternating current power supply apparatus 20 supplies a power to an electronic device (not shown in FIG. 3).

The switch controller 116 is configured to conduct the first switch unit 104 with the surge. The first transient voltage surge suppressor 108 is used to suppress and absorb the surge. The rectification unit 102 is used to rectify the surge (because the first transient voltage surge suppressor 108 is a unidirectional component).

Moreover, the first switch unit 104 is, for example but not limited to, a metal oxide semiconductor field effect transistor (MOSFET), an insulation gate bipolar transistor (IGBT), a silicon controlled rectifier (SCR), or a bipolar junction transistor (BJT).

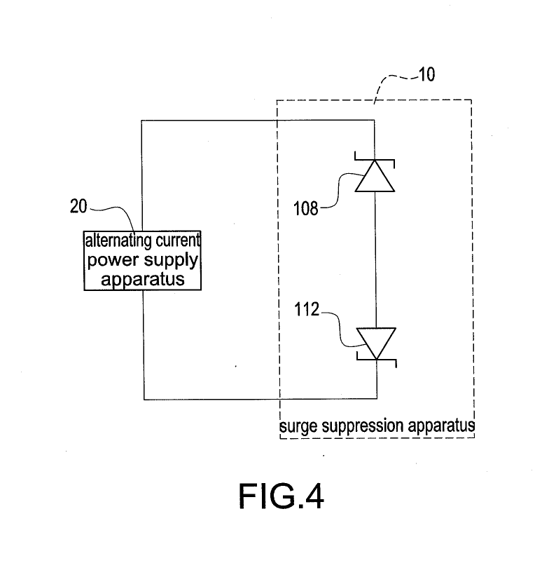

FIG. 4 shows a block diagram of a fourth embodiment of the surge suppression apparatus of the present invention. A surge suppression apparatus 10 is applied to an alternating current power supply apparatus 20. The surge suppression apparatus 10 includes a first transient voltage surge suppressor 108 and a second transient voltage surge suppressor 112.

The alternating current power supply apparatus 20 is electrically connected to the first transient voltage surge suppressor 108 and the second transient voltage surge suppressor 112. The first transient voltage surge suppressor 108 is electrically connected to the second transient voltage surge suppressor 112.

The first transient voltage surge suppressor 108 and the second transient voltage surge suppressor 112 are high impedance components without the surge. The first transient voltage surge suppressor 108 and the second transient voltage surge suppressor 112 are low impedance components with the surge.

The alternating current power supply apparatus 20 supplies a power to an electronic device (not shown in FIG. 4) without the surge. The first transient voltage surge suppressor 108 and the second transient voltage surge suppressor 112 are used to suppress and absorb the surge. The second transient voltage surge suppressor 112 is used to suppress and absorb the reversed surge.

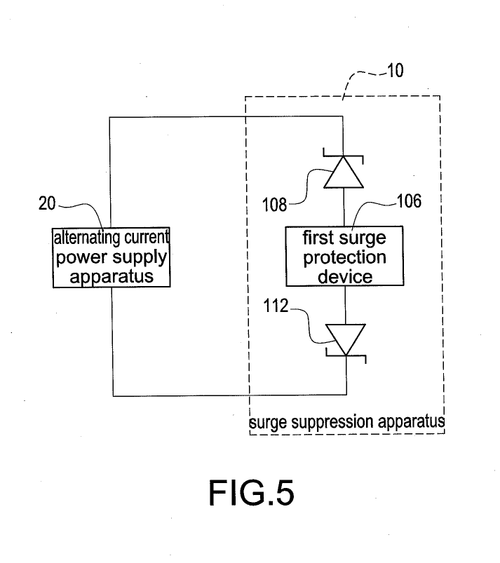

FIG. 5 shows a block diagram of a fifth embodiment of the surge suppression apparatus of the present invention. FIG. 5 is similar to FIG. 4. Therefore, the descriptions for FIG. 5 are omitted. Moreover, the surge suppression apparatus 10 further includes a first surge protection device 106. The first surge protection device 106 is, for example but not limited to, a metal oxide varistor, a gas tube, or a resistor.

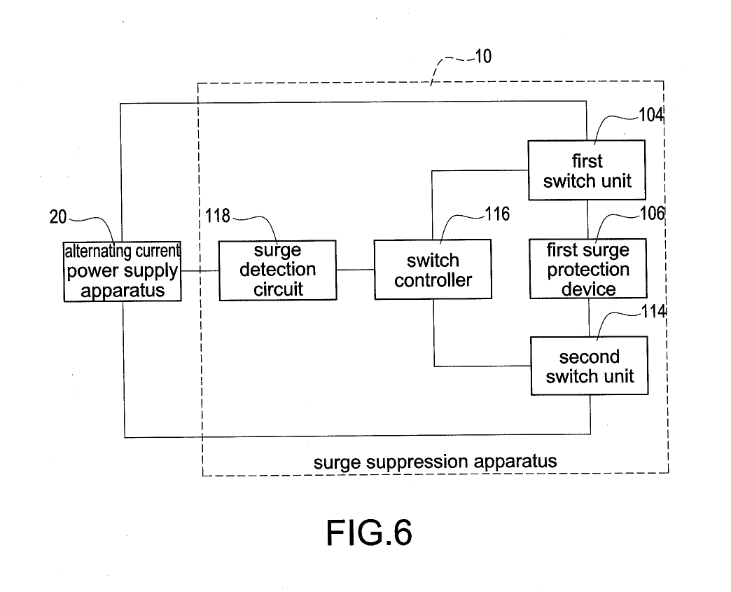

FIG. 6 shows a block diagram of a sixth embodiment of the surge suppression apparatus of the present invention. A surge suppression apparatus 10 is applied to an alternating current power supply apparatus 20. The surge suppression apparatus 10 includes a first switch unit 104, a first surge protection device 106, a second switch unit 114, a switch controller 116, and a surge detection circuit 118.

The alternating current power supply apparatus 20 is electrically connected to the surge detection circuit 118, the first switch unit 104, and the second switch unit 114. The switch controller 116 is electrically connected to the surge detection circuit 118, the first switch unit 104, and the second switch unit 114. The first surge protection device 106 is electrically connected to the first switch unit 104 and the second switch unit 114.

The surge detection circuit 118 detects the surge and informs the switch controller 116. The switch controller 116 is configured to cut off the first switch unit 104 and the second switch unit 114 without the surge. The alternating current power supply apparatus 20 supplies a power to an electronic device (not shown in FIG. 6).

The switch controller 116 is configured to conduct the first switch unit 104 and the second switch unit 114 with the surge. The first surge protection device 106 is used to suppress and absorb the surge.

Moreover, the first surge protection device 106 is, for example but not limited to, a metal oxide varistor, a gas tube, a resistor, or a transient voltage surge suppressor.

The first switch unit 104 is, for example but not limited to, a metal oxide semiconductor field effect transistor, an insulation gate bipolar transistor, a silicon controlled rectifier, or a bipolar junction transistor. The second switch unit 114 is, for example but not limited to, a metal oxide semiconductor field effect transistor, an insulation gate bipolar transistor, a silicon controlled rectifier, or a bipolar junction transistor.

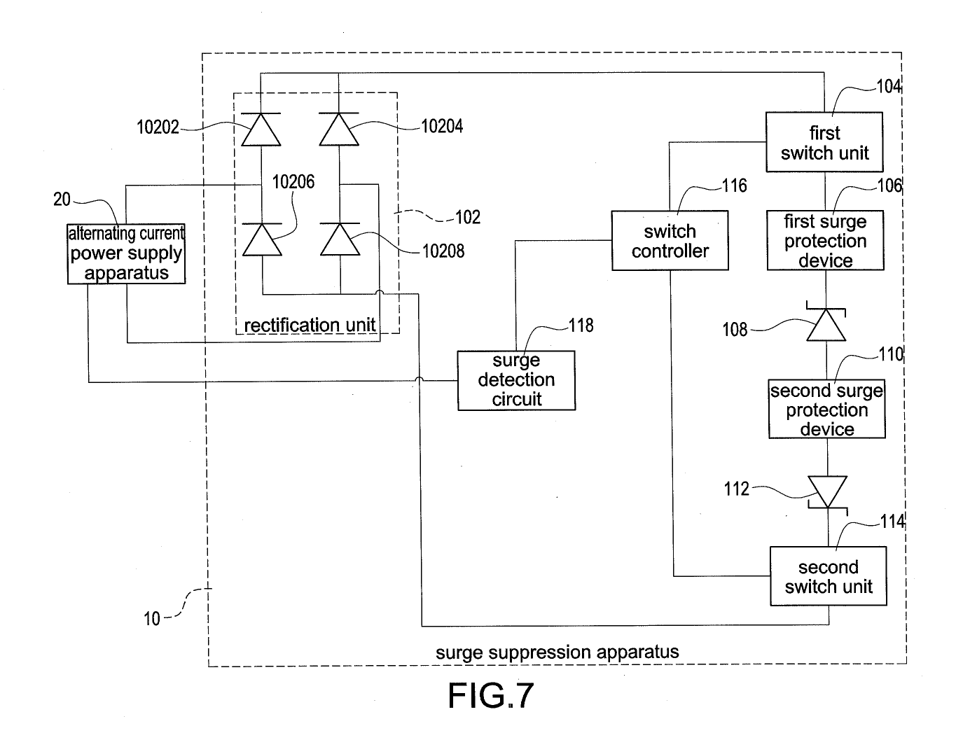

FIG. 7 shows a block diagram of a seventh embodiment of the surge suppression apparatus of the present invention. A surge suppression apparatus 10 is applied to an alternating current power supply apparatus 20. The surge suppression apparatus 10 includes a rectification unit 102, a first switch unit 104, a first surge protection device 106, a first transient voltage surge suppressor 108, a second surge protection device 110, a second transient voltage surge suppressor 112, a second switch unit 114, a switch controller 116, and a surge detection circuit 118.

The rectification unit 102 includes a first diode 10202, a second diode 10204, a third diode 10206, and a fourth diode 10208.

The alternating current power supply apparatus 20 is electrically connected to the first diode 10202, the second diode 10204, the third diode 10206, the fourth diode 10208, and the surge detection circuit 118. The first diode 10202 is electrically connected to the second diode 10204, the third diode 10206, and the first switch unit 104. The second diode 10204 is electrically connected to the fourth diode 10208 and the first switch unit 104. The third diode 10206 is electrically connected to the fourth diode 10208 and the second switch unit 114. The fourth diode 10208 is electrically connected to the second switch unit 114.

The switch controller 116 is electrically connected to the surge detection circuit 118, the first switch unit 104, and the second switch unit 114. The first surge protection device 106 is electrically connected to the first switch unit 104 and the first transient voltage surge suppressor 108. The second surge protection device 110 is electrically connected to the first transient voltage surge suppressor 108 and the second transient voltage surge suppressor 112. The second transient voltage surge suppressor 112 is electrically connected to the second switch unit 114.

The first transient voltage surge suppressor 108 and the second transient voltage surge suppressor 112 are high impedance components without the surge. The first transient voltage surge suppressor 108 and the second transient voltage surge suppressor 112 are low impedance components with the surge.

The surge detection circuit 118 detects the surge and informs the switch controller 116. The switch controller 116 is configured to cut off the first switch unit 104 and the second switch unit 114 without the surge. The alternating current power supply apparatus 20 supplies a power to an electronic device (not shown in FIG. 7).

The switch controller 116 is configured to conduct the first switch unit 104 and the second switch unit 114 with the surge. The first surge protection device 106, the first transient voltage surge suppressor 108, the second surge protection device 110, and the second transient voltage surge suppressor 112 are used to suppress and absorb the surge. The rectification unit 102 is used to rectify the surge (because the first transient voltage surge suppressor 108 is a unidirectional component). The second transient voltage surge suppressor 112 is used to suppress and absorb the reversed surge.

Moreover, the first surge protection device 106 is, for example but not limited to, a metal oxide varistor, a gas tube, or a resistor. The second surge protection device 110 is, for example but not limited to, a metal oxide varistor, a gas tube, or a resistor.

The first switch unit 104 is, for example but not limited to, a metal oxide semiconductor field effect transistor, an insulation gate bipolar transistor, a silicon controlled rectifier, or a bipolar junction transistor. The second switch unit 114 is, for example but not limited to, a metal oxide semiconductor field effect transistor, an insulation gate bipolar transistor, a silicon controlled rectifier, or a bipolar junction transistor.

The present invention is applied to a high voltage system (the alternating current power supply apparatus 20 outputs, for example but not limited to, 240 volts). The present invention clamps the surge voltage to the low voltage (for example, the clamping voltage of related art is 880 volts, but the clamping voltage of the present invention is 650 volts). The present invention does not use fuse, so the present invention can restore automatically. Moreover, the present invention can suppress and absorb the surge quickly.

Although the present invention has been described with reference to the preferred embodiment thereof, it will be understood that the invention is not limited to the details thereof. Various substitutions and modifications have been suggested in the foregoing description, and others will occur to those of ordinary skill in the art. Therefore, all such substitutions and modifications are intended to be embraced within the scope of the invention as defined in the appended claims.

1. A surge suppression apparatus applied to an alternating current power supply apparatus, the surge suppression apparatus including:
a rectification unit electrically connected to the alternating current power supply apparatus; and
a first transient voltage surge suppressor electrically connected to the rectification unit,
wherein the rectification unit includes:
a first diode electrically connected to the alternating current power supply apparatus and the first transient voltage surge suppressor;
a second diode electrically connected to the alternating current power supply apparatus, the first transient voltage surge suppressor, and the first diode;
a third diode electrically connected to the alternating current power supply apparatus, the first transient voltage surge suppressor, and the first diode;
a fourth diode electrically connected to the alternating current power supply apparatus, the first transient voltage surge suppressor, the second diode, and the third diode;
a first switch unit electrically connected to the first transient voltage surge suppressor;
a switch controller electrically connected to the first switch unit; and
a surge detection circuit electrically connected to the alternating current power supply apparatus and the switch controller,
wherein the first transient voltage surge suppressor is a high impedance component without the surge; the first transient voltage surge suppressor is a low impedance component with the surge;
wherein the surge detection circuit detects the surge and informs the switch controller; the switch controller is configured to cut off the first switch unit without the surge; the alternating current power supply apparatus to an electronic device;
wherein the switch controller is configured to conduct the first switch unit with the surge; the first transient voltage surge suppressor is used to suppress and absorb the surge; the rectification unit is used to rectify the surge.

2. The surge suppression apparatus in claim 1, further including a first surge protection device electrically connected to the first diode, the second diode, and the first transient voltage surge suppressor.

3. (canceled)

4. The surge suppression apparatus in claim 2, further including a second surge protection device electrically connected to the third diode, the fourth diode, and the first transient voltage surge suppressor.

5. The surge suppression apparatus in claim 4, further including a second transient voltage surge suppressor electrically connected to the third diode, the fourth diode, and the second surge protection device.

6. The surge suppression apparatus in claim 5, further including a second switch unit electrically connected to the third diode, the fourth diode, and the second transient voltage surge suppressor.

7-8. (canceled)

9. The surge suppression apparatus in claim 6 8, wherein the first surge protection device is a metal oxide varistor, a gas tube, or a resistor; the second surge protection device is a metal oxide varistor, a gas tube, or a resistor.

10. The surge suppression apparatus in claim 9, wherein the first switch unit is a metal oxide semiconductor field effect transistor, an insulation gate bipolar transistor, a silicon controlled rectifier, or a bipolar junction transistor; the second switch unit a metal oxide semiconductor field effect transistor, an insulation gate bipolar transistor, a silicon controlled rectifier, or a bipolar junction transistor.

11. A surge suppression apparatus applied to an alternating current power supply apparatus, the surge suppression apparatus including:
a rectification unit electrically connected to the alternating current power supply apparatus; and
a first transient voltage surge suppressor electrically connected to the rectification unit,
wherein the rectification unit includes:
a first diode electrically connected to the alternating current power supply apparatus and the first transient voltage surge suppressor;
a second diode electrically connected to the alternating current power supply apparatus, the first transient voltage surge suppressor, and the first diode;
a third diode electrically connected to the alternating current power supply apparatus, the first transient voltage surge suppressor, and the first diode; and
a fourth diode electrically connected to the alternating current power supply apparatus, the first transient voltage surge suppressor, the second diode, and the third diode, and
the surge suppression apparatus further includes a second transient voltage surge suppressor electrically connected to the third diode and the fourth diode.
